(19) United States
(12) Patent Application Publication
(10) Pub. No.: US 2008/0251218 A1
(43) Pub. Date: Oct. 16, 2008

(54) Storable wind storm shutter system (for window and door openings on residential and commercial buildings)

(76) Inventor: Charles H. Booth, Birmingham, AL (US)

Correspondence Address: Charles H. Booth, 4324 Old Brook Trail, Birmingham, AL, 35243, US

(21) Appl. No.: 11/704,134

(22) Filed: Feb. 8, 2007

(51) Int. Cl. E06B 9/02

(52) U.S. Cl. 160/172 V

(57) ABSTRACT

Attachments to a building aperture frame alongside door or window openings. The attachments are comprised of two vertical channels, one horizontal channel, one vertical motion limiter bracket and multiple connector tubes (the number of which is dependent on the height of the opening which is being protected. The two vertical channels are of sufficient length to be at least two inches taller than the opening which is being protected. One vertical channel is mounted on each side of the channel to be protected. The horizontal channel is of such length that it will span the horizontal distance between the two mounted vertical channels. The vertical motion limiter bracket is mounted on the structure centered above the opening that is being protected. The connector tubes are used to connect horizontal wood slats, the other ends of which will rest in the vertical channels. The slats will be stacked one upon another. The bottom slat will rest in the horizontal channel. The top horizontal slat will be limited by the vertical motion limit bracket. The connector tubes will each connect to the tube below it for additional stability. No connector tubes need be used for narrow window openings. The assembled pieces together form a storm shutter system. Major elements of the system can be disassembled and easily stored until needed. Alternative installation utilizes H-channel in place of the connector tubes.

I claim priority under the Provisional Application filed Feb. 8, 2006 for which confirmation number 9936 was assigned on Feb. 27, 2006.

### BACKGROUND OF THE INVENTION

A variety of systems are available to provide wind storm protection to glass door and window openings on buildings that incorporate glass doors and windows. These protection systems range from crude plywood boards anchored to the surface of the building with nails, to electrically-operated, flexible steel shutters which can be rolled down from above or laterally from one or both side in a storage position to extend to cover window and door openings. Between these two extremes, there exists other types of shutter systems such as that which is disclosed in U.S. Pat. No. 4,685,261 to Seaquist. The most prevalent system in use is the temporary attachment of commonly available plywood sheets when a storm is imminent.

Conventional methods of protecting windows against adverse weather conditions include nailing plywood over the window or covering the window with permanently attached hinged shutters which are swung together over the window when required and are swung apart and decorative in nature when not being used. Further, removable protection panels are found in U.S. Pat. Nos. 2,568,195; 2,572,764; 2,878,536; 3,745,704; and Canada Pat. No. 687,915. These patents disclose upper and lower brackets mounted adjacent to the window structure and a panel of heavy material held in place between the two brackets to protect the window. Additionally, even the removable shutter systems such as U.S. Pat. No. 4,685,261 require the storage and use of large and expensive pieces or sections.

With the exception of window protection systems that rely simply on plywood or some other material nailed to the exterior of a building construction, most storm shutters require the existence of previously-installed shutter systems. In the case of roll-down or roll-across shutters, the entire shutter is rolled inside a horizontal casing attached permanently above a window or door or inside one or two vertical casings attached on a side or sides of the portal. In addition, for roll-down shutters, guide tracks must be provided along the vertical portions of the window or doorway to guide the shutter as it is rolled up and down in front of a window or door to be protected.

This invention is designed to alleviate the problems found in shutter mounting systems of the prior art, and to provide a simple to use system, economical system that is capable of securely maintaining a storm shutter firmly in position but which can be easily removed and stored when not needed.

### SUMMARY OF THE INVENTION

The apparatus according to the present invention is a set of metal brackets and channels which are attached to a building structure alongside and around door or window openings. When mounted in place and assembled, the system creates a sturdy barrier against damage to the portal that might result from wind storms. The vertical brackets and the vertical motion limiter brackets are mounted to the structure and remain in place, while the slats can be removed, disassembled from the connector tubes (if such are used), and the horizontal channel can be disassembled from its extensions so that these components can be easily stored for re-use

The components are comprised of two vertical channels, one horizontal channel with channel locators, three vertical motion limiter brackets and multiple connector tubes (the number of which is dependent on the height of the opening which is being protected). The two vertical channels will be of sufficient length to be at least two inches taller than the opening which is being protected when the bottom of the mounted vertical channels is even with the bottom of the portal. One vertical channel will be mounted on each side of the channel to be protected. The horizontal channel is positioned at the bottom of the portal, between the two vertical channels and is held in its operational position by channel locators which connect with the vertical channels. Each channel locator has a two inch long tab or “tongue,” at one end which is at a 30 degree angle to the horizontal plane of the flat surface of the channel locator tab and which can be inserted into to the slot at the bottom of the vertical channel. The remaining length of the channel locator is of sufficient width to allow it to lie flat in the horizontal channel. The weight of the stacked slats will hold the horizontal channel and the channel locators in place. The vertical motion limiter brackets will be mounted on the structure centered above the opening that is being protected and one of which will be mounted above, at the top of, each of the two vertical channels. The connector tubes will be used to connect horizontal wood slats, the ends of which will rest in the vertical channels. The slats will be stacked one upon another. The bottom slat will rest in the horizontal channel. The top horizontal slat will be limited by the vertical motion limit bracket. The connector tubes will each connect to the tube below it for additional stability. No connector tubes need be used for narrow window openings. The pieces together form a storm shutter system. Major elements of the system can be disassembled and easily stored until needed. When needed, the storm shutter system can be easily assembled and put in place from either inside of the structure or outside of the structure.

An alternative mounting process, in which a section of H-channel the same length and width as the Item 4 channel depicted in FIG. 5 is used at the top and bottom of each slat in place of the connector tube for each slat, which is Item 3 in FIG. 4, makes installation an easier process, while creating minimal compromises in system strength. In such mounting process, a spacer, the same width and height as the slat is used as a spacer between each slat, and a screw is used to secure each H-channel to each spacer

### BRIEF DESCRIPTION OF THE DRAWINGS

(NOTE: Drawings are based on use of invention on a doorway that is 100 inches in width utilizing 1 inch by 6 inch wood boards as slats. The invention can be used on larger and smaller portals and can utilize wood boards or composite materials of different sizes.)

FIG. 1 is an elevation view of a first embodiment of a building aperture frame system according to the present invention, all pieces required for a portal which is the size and shape of a typical sliding patio door are shown assembled and in place.

FIG. 2 is a detailed view of Part No. 1 from FIG. 1, the Vertical Channel.

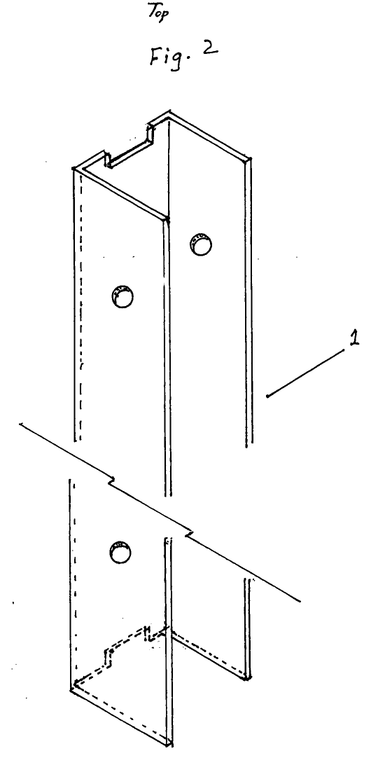

FIG. 3 is a detailed view of Part No. 2 from FIG. 1, the Horizontal Channel.

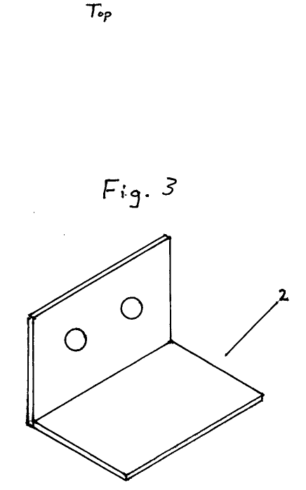

FIG. 4 is and Part No. 3 from FIG. 1, the Channel Locator Tab.

FIG. 5 is a detailed view of Part No. 4 from FIG. 1, the Vertical Motion Limiter Bracket.

FIG. 6 is a detailed view of Part No. 5 from FIG. 1, the Connector Tube, into which Part No. 6 from FIG. 1, the Slat, is inserted.

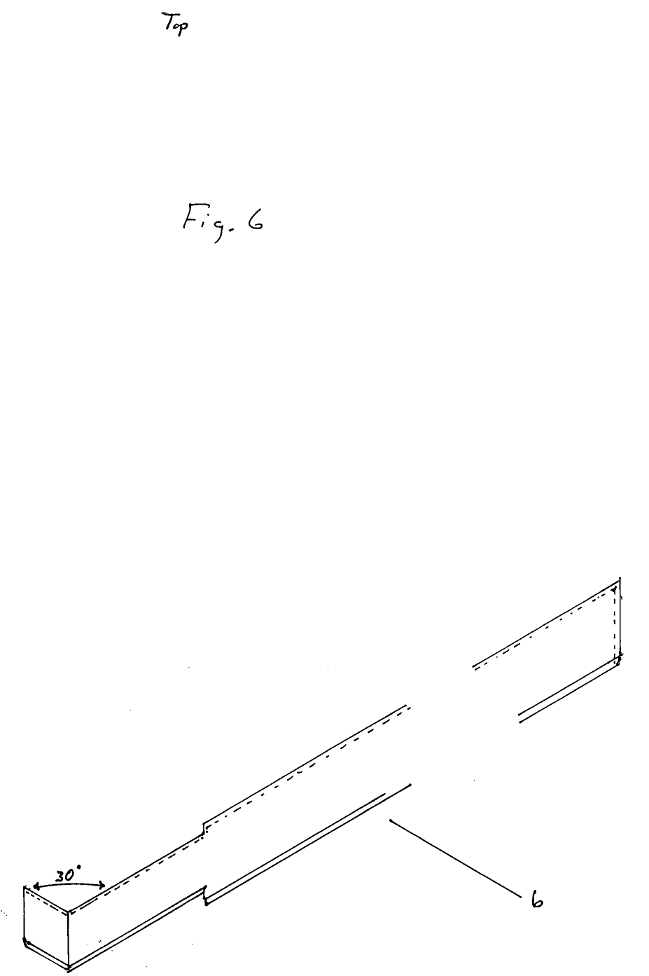

### DETAILED DESCRIPTION OF THE INVENTION

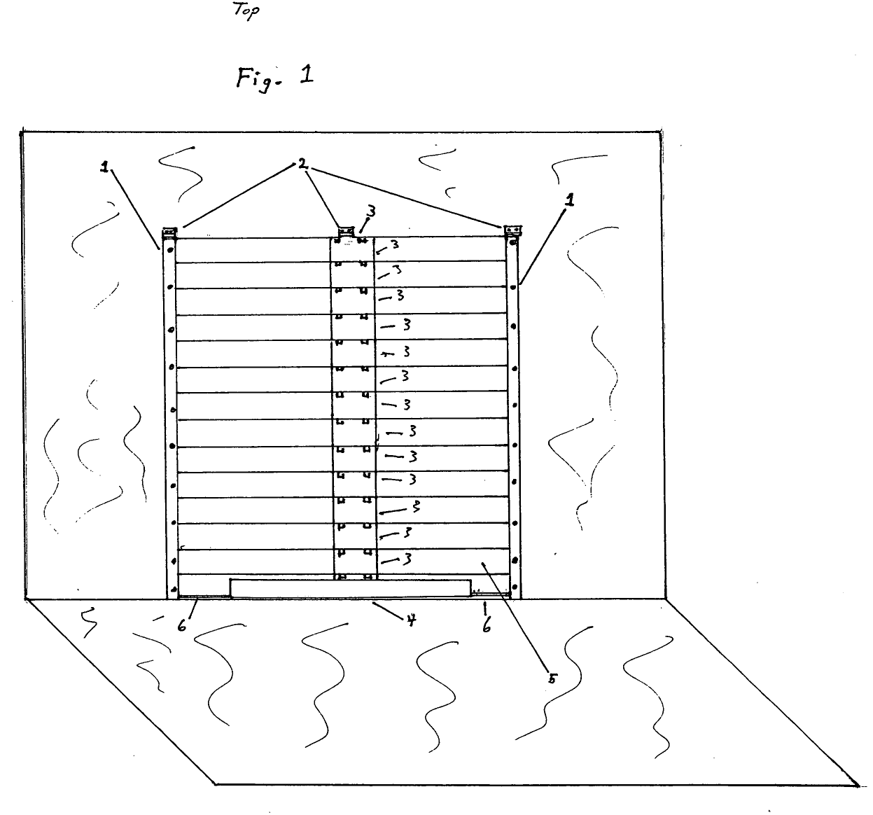

This invention relates to a metal frame that is exterior to a structure portal such as a typical window or door, into which commonly available wood or composite boards or sheets can be placed such that the parts become a storm shutter-like protection against damage from wind storms. FIG. 1 depicts a completed system installed on a typical residential sliding glass patio door that is 78 inches in height and 108 inches in width. The slat material used in the FIG. 1 image is 1 inch by 6 inch wood boards.

As shown in FIG. 1 the system according to a first embodiment is comprised of vertical channels, Part No. 1, which are U-shaped metal channels which have a notch at top and bottom on the closed end of the “U” and mounting bolt/screw apertures drilled in the opposed sides of the “U”. The notches and the holes are arranged so that the vertical channels can be used interchangeably.

Also in FIG. 1, three vertical motion limit brackets, Part No. 2, are mounted across the top of the portal: one above each of the vertical channels, and one centered between the two vertical channels.

Also in FIG. 1, the horizontal channel, Part No. 3, is positioned at the bottom of the stacked slats between the vertical channels, Part No. 1, and held in the proper position by the channel locators.

The slats, Part No. 5, which in this embodiment of the system are each composed of two pieces of wood board, are arranged such that two boards are joined by a connector tube, Part No. 6, in order to form a slat long enough to reach from one vertical channel, Part No. 1, to the other vertical channel, and are stacked, one upon another, such that the lower most slat rests in the horizontal channel and each high stacked slat rests on the next lower slat such that the tabs on one surface of connector tube resides in the slot on the connector tube below it. The slats are stacked until the top surface of the uppermost slat rests against the bottom horizontal surface of the vertical motion limit slats. Detailed system installation instructions will describe how slats must be raised so that the last of the slats can be installed from inside of the structure without access to the exterior.

All parts are mounted to the structure through the use of commonly available ⅜ inch galvanized hex-head bolts (or other screws/bolts of similar size) that are 2½ inches in length. The exact mounting bolt utilized is dictated by the construction materials utilized in the structure to which it is mounted. The connector tubes are secured to the slats by using one commonly available 5/16 inch galvanized hex-head wood bolt that is 1⅜ inches in length for each slat.

According to the present invention, the frame system shown in FIG. 1 can be mounted around most window or doorway apertures. Once mounted in the proper position, the vertical channels remain in place while all other components are stored until such time as they are needed. The components are then easily added to the already mounted vertical channels to form a strong barrier against wind storm damage.

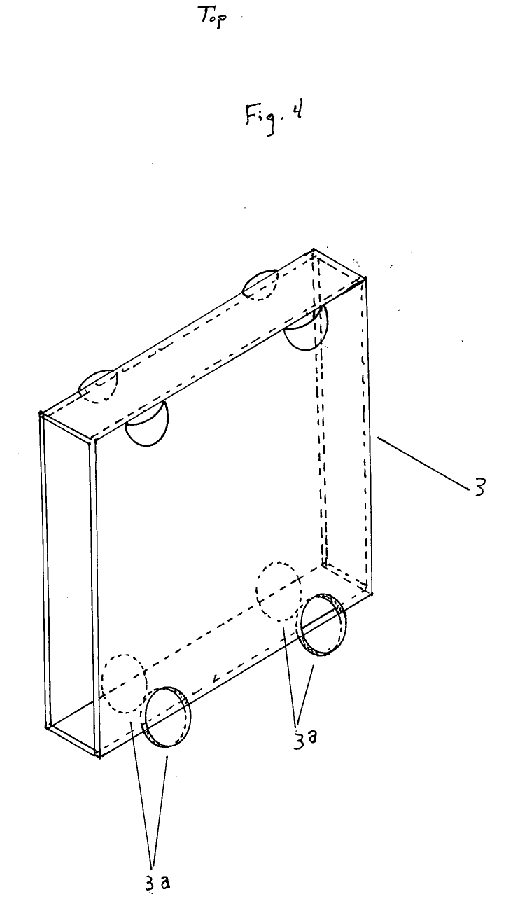

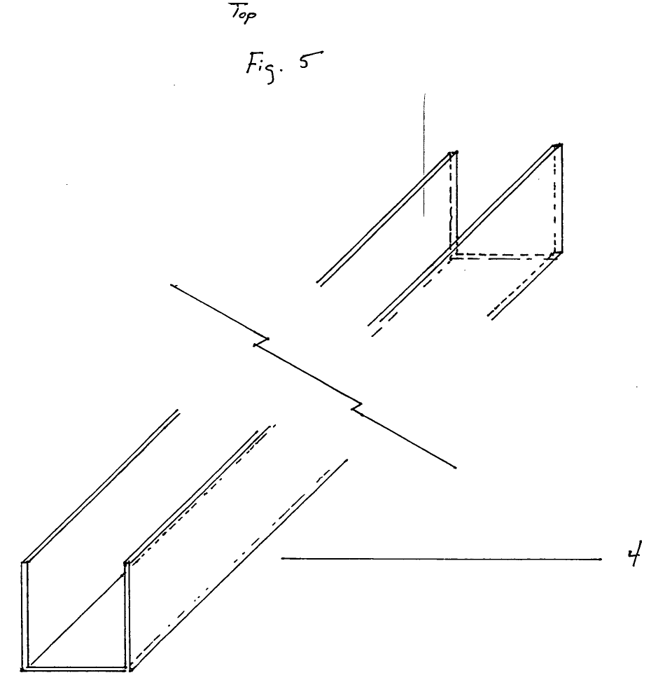

An alternative mounting process, in which a section of H-channel the same length and width as the Item 4 channel depicted in FIG. 5 is used in place of the connector tube, which is Item 3 in FIG. 4, placed both above and below each slat, makes installation an easier process, while creating minimal compromises in system strength. In such mounting process, a spacer, the same width and height as the slat is used as a spacer between each slat, and a screw is used to secure each H-channel to each spacer

The present invention provides exceptional strength, easy installation and removal from inside or outside of the structure, low cost that approaches that of a nailed in place sheet of plywood and the absence of negative impact on the exterior design. When the present invention is used to protect a smaller portal, that is a portal that is less than 36 inches in width, the slats may be used without the connector tubes except for one slat which will require a connector tube in order to facilitate interior installation. In such use without the connector tubes, the horizontal channels, channel locators, vertical motion limit brackets and vertical channels are all used. Only the connector tubes may be left out of such an installation.

I claim:

1. A frame structure, made of galvanized, painted or powder coated metal, used, when attached to a building, for mounting storm shutters for building portal protection comprising five components (although each system may use more than one of each of the components or may not use one of the components for smaller portals):
(a) U-shaped vertical channels, two of which are used in each installation, which are of sufficient length to be at least two inches taller than the opening which is being protected. One vertical channel will be mounted on the structure on each side of the portal to be protected. The width of the vertical channel varies dependent on the slat material (described below) that is utilized in each installation. The vertical channels each have a notch at the top and bottom on the closed end. This notch serves to allow insertion of a tab on the horizontal bottom channel locators in order to provide strength. The connector tubes will be used to connect horizontal wood slats, the ends of which will rest in the vertical channels. The slats will be stacked one upon another. The bottom slat will rest in the horizontal channel. The top horizontal slat will be limited by the vertical motion limit bracket. The connector tubes will each connect to the tube below it for additional stability. No connector tubes need be used for narrow window openings. The pieces together form a storm shutter system. Major elements of the system can be disassembled and easily stored until needed. Only the vertical channels and the vertical motion limiter brackets remain in position and attached to the structure when other parts are stored.
(b) a U-shaped horizontal channel which is of such length that it will span at least half of the horizontal distance between the two mounted vertical channels. The depth of the channel is the same as the depth of the vertical channels and varies depending on the material used for the horizontal slats. The horizontal channel is held in its operational position at the bottom of the portal opening between the vertical channels by channel locators which connect with the vertical channels. Each channel locator has a two inch long tab or “tongue,” at one end which is at a 30 degree angle to the horizontal plane of the flat surface of the channel locator tab and which can be inserted into to the slot at the bottom of the vertical channel. The remaining length of the channel locator is of sufficient width to allow it to lie flat in the horizontal channel. The weight of the stacked slats will hold the horizontal channel and the channel locators in place while the horizontal channel and the channel locators hold the slats in place.
(c). a vertical motion limiter bracket, three of which are used in each installation. One vertical motion limiter is mounted on the structure centered above the opening that is being protected and one at the top of each of the two vertical channels. The bracket is “L” shaped. When mounted to the structure, part of the bracket extends perpendicular to the structure above the opening to be protected. This portion of the bracket that extends perpendicular to the structure shall be, in length, 1.5 times the width of the vertical and horizontal channels (which are the same size in any installation). A tension adjustment screw may be used on the center vertical motion limiter bracket for additional tightening of the system parts.
(d). multiple connector tubes which serve to connect the pieces of material that are used as slats. Each slat must be two pieces of the slat material if the portal being protected is more than 36″ in width. The tubes are rectangular in cross section. The inside cross section dimensions of a connector tube are 5% larger than the outside dimensions of the slat material with which they are used, and the length of each connector tube varies from 6 inches to 10 inches and is directly proportional to the largest cross sectional dimension of the connector tube with which it is used. Each connector tube has slots and tabs such that the tabs of one connector tube will fit into the slots on the tube below it when the slats/connectors are stacked in the vertical channels. The insertion of the tabs into the slots adds strength to the structure as protection against inward deflection of the slats. Each connector tube has holes drilled in the horizontal faces so that screws can be run through the connector tube into the slats in order to prevent lateral movement of the pieces when the slats are stacked in place.
(e). multiple slats made of wood or composite material that will serve as horizontal slats that can be joined, if length requires such joining, by the connector tubes and are then stacked in the vertical channels with the bottom most slat resting in the horizontal channel and the top-most slat retained by the vertical motion limiter.

2. The frame structure as recited in claim 1 including the vertical channels where the vertical channels are mounted on the structure.

3. The frame structure as recited in claim 1 where the vertical channels interact with and connect to the horizontal channel via the channel locators.

4. The frame structure as recited in claim 1 where the vertical motion limiter when mounted to the structure prevents up and down movement of the slats which have been placed in the channel.

5. The frame structure as recited in claim 1 where the slats, either with the use of the connector tubes or without the use of the connector tubes or with the use of the H-channel, slide into and are stacked in the vertical channels and rest, on the bottom of this stack of slats, in the horizontal channel.

6. The complete system of vertical channels, vertical motion limiter, horizontal channel, channel locators and connector tubes which together (with or without the connector tubes), when used with horizontal slats, provide protection against horizontal intrusion into the protected portal from debris and materials driven by storm winds.

7. Alternative mounting process in which a section of H-channel the same length and width as the Item 4 channel depicted in FIG. 5 is used in place of the connector tube, which is Item 3 in FIG. 4, placed both above and below each slat. In such mounting process, a spacer, the same width and height as the slat is used as a spacer between each slat, and a screw is used to secure each H-channel to each spacer.
